(19) United States
(12) Patent Application Publication
(10) Pub. No.: US 2004/0181292 A1
(43) Pub. Date: Sep. 16, 2004

(54) Multipurpose remote controller and method for controlling the same

(76) Inventors: Sam Chul Ha, Kyongsangnam-do (KR); Seung Myun Baek, Kyongsangnam-do (KR); Koon Seok Lee, Kyongsangnam-do (KR); Jeong Hyun Lim, Kyongsangnam-do (KR); Hwan Jong Choi, Kyongsangnam-do (KR); Ja In Koo, Kyongsangnam-do (KR); Dae Woong Kim, Kyongsangnam-do (KR); Sung Hwan Kang, Kyongsangnam-do (KR)

Correspondence Address: MCKENNA LONG & ALDRIDGE LLP, 1900 K STREET, NW, WASHINGTON, DC, 20006, US

(21) Appl. No.: 10/481,816

(22) PCT Filed: Apr. 9, 2002
(86) PCT No.: PCT/KR02/00637

(30) Foreign Application Priority Data
Jun. 26, 2001 (KR) 2001/36615

(51) Int. Cl. G05B 11/01

(52) U.S. Cl. 700/17; 340/825.71

(57) ABSTRACT

A multipurpose remote controller and method for controlling the same is disclosed, which includes a user interface unit to which a control command signal is input by a user from outside, wire and wireless transmitting/receiving units for transmitting the control command signal input from the user interface unit to corresponding apparatuses, and for receiving operation state signals of the corresponding apparatuses, a central processor for controlling the user interface and wire and wireless transmitting/receiving units, a storage storing data for controlling the central processor, and a display unit for displaying control keys under control of the central processor and for displaying operation state and results.

### TECHNICAL FIELD

The present invention relates to a remote controller, and more particularly, to a multipurpose remote controller and method for controlling the same, capable of controlling a plurality of different kinds of appliances entirely or separately by using one remote controller.

### BACKGROUND ART

A home networking system, in conforming to IEEE1394 and IEC61883, for networking and then controlling household appliances, such as a plurality of peripheral apparatuses in the house including PC, cellular phone, refrigerator, washing machine etc., is currently under development.

The plurality of networked appliances is controlled through one main apparatus as a whole, or each appliance is controlled by a corresponding remote controller separately.

A problem of using main apparatus is that a user has to move personally to the main apparatus that is usually fixed on a certain position, in order to control the plural appliances.

In addition, if a remote controller is assigned to every apparatus, respectively, it will cause a lot of confusion to the user because as a user buys more apparatuses, the user naturally will possess more remote controllers to operate. Considering that in many cases, other apparatuses within the operation range of a remote controller for another particular apparatus operate at the same time, the user has to stop the operation of other unnecessary apparatuses or leave them on. This obviously wastes a lot of power, and shortens lifespan of apparatuses.

### DISCLOSURE OF INVENTION

It is, therefore, an object of the present invention to provide a multipurpose remote controller and method for controlling the same, enabling a user to control a plurality of networked apparatuses as a whole or control each apparatus separately by using one remote controller.

To achieve the above object, there is provided a multipurpose remote controller, which includes a user interface unit to which a control command signal is input by a user from outside; wire and wireless transmitting/receiving units for transmitting the control command signal input from the user interface unit to corresponding apparatuses, and for receiving operation state signals of the corresponding apparatuses; a central processor for controlling the user interface and wire and wireless transmitting/receiving units; a storage for storing data necessary to control the central processor, and a display unit for displaying control keys under control of the central processor and for displaying operating state and results.

Another aspect of the present invention provides a method for controlling the multipurpose remote controller, which includes the steps of: configuring a home network for intercommunication by networking household apparatuses; selecting a particular apparatus to be controlled through an initial screen on which the networked apparatuses are divided according to apparatus or function; displaying a control menu and present operation state of the particular apparatus; selecting a control command for operating a corresponding apparatus through the control menu being displayed; performing the corresponding operation as the selected control command is input, and then signaling the operation state of the apparatus to the multipurpose remote controller; and if the state of the apparatus is changed or a new apparatus is added or an existing apparatus is deleted, updating the initial screen and then repeating the whole procedure.

### BRIEF DESCRIPTION OF DRAWINGS

The above objects, features and advantages of the present invention will become more apparent from the following detailed description when taken in conjunction with the accompanying drawings, in which:

FIG. 1 is a schematic diagram of a multipurpose remote controller according to a related art;

FIG. 2A diagrammatically illustrates an initial screen according to one embodiment of the present invention;

FIG. 2B diagrammatically illustrates a small group of a particular apparatus being selected from the initial screen of FIG. 2A;

FIG. 2C depicts a control menu and a screen for present operation state according to the embodiment of the present invention;

FIG. 2D diagrammatically shows an initial screen according to another embodiment of the present invention; and

FIG. 3 is a flow chart illustrating a method for controlling the multipurpose remote controller according to the present invention.

### BEST MODE FOR CARRYING OUT THE INVENTION

A preferred embodiment of the present invention will now be described with reference to the accompanying drawings.

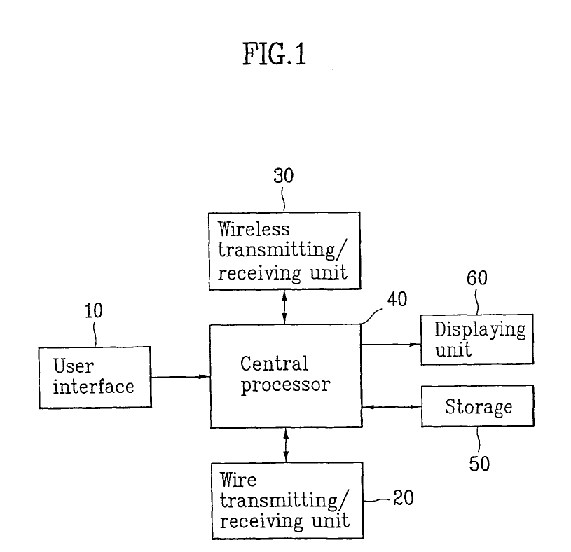

FIG. 1 is a schematic diagram of a multipurpose remote controller according to a related art. As shown in the drawing, the multipurpose remote controller includes a user interface unit 10 to which a control command signal is input by a user from outside, wire and wireless transmitting/receiving units 20 and 30 for transmitting the control command signal input from the user interface unit 10 to corresponding apparatuses, and for receiving operation state signals of the corresponding apparatuses, a central processor 40 for controlling the user interface and wire and wireless transmitting/receiving units 20 and 30, a storage 50 for storing data for controlling the central processor 40, and a display unit 60 for displaying control keys under control of the central processor 40 and for displaying operating state and results.

The wireless transmitting/receiving unit 30 connects to Internet product that transmits/receives wirelessly, and performs RF or infrared communications.

The wire transmitting/receiving unit 20 connects to a web page, and then updates apparatuses and the multipurpose remote controller, thereby performing wire communications with each apparatus.

More details on the operation of the multipurpose remote controller are now described with reference to drawings.

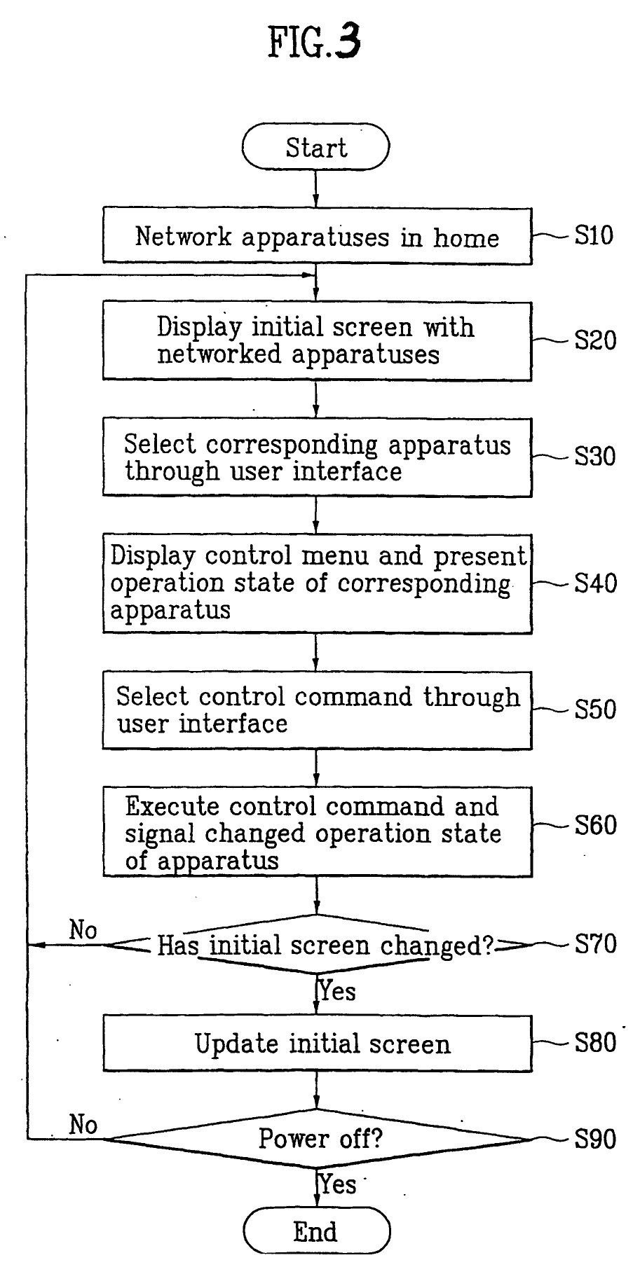

FIG. 3 is a flow chart illustrating a method for controlling the multipurpose remote controller according to the present invention.

As shown in the drawing, first of all, apparatuses in the house are networked to configure a home network for interconnection one another (S10).

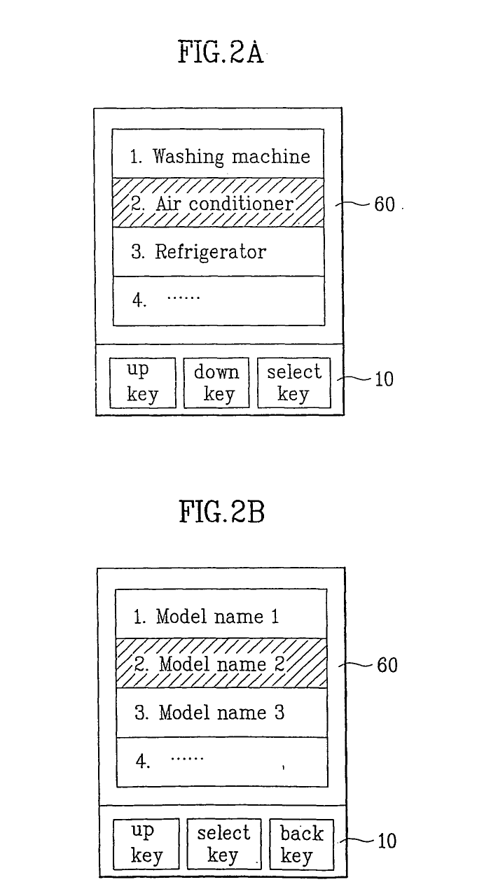

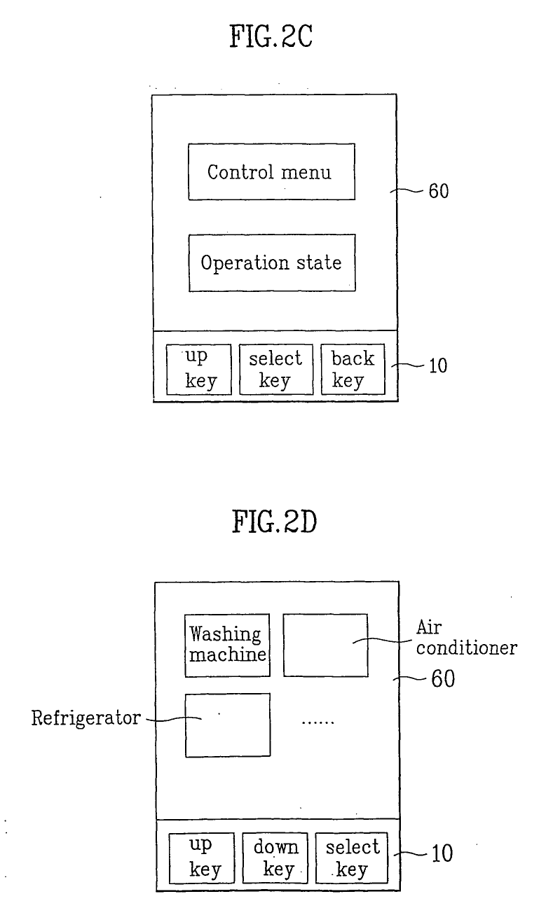

Displayed on displaying unit 60 of the multipurpose remote controller is an initial screen on which the networked apparatuses are divided according to apparatus and function (S20). A preferable initial screen is illustrated in FIG. 2A. One can have the list of apparatuses by using characters as shown in FIG. 2A, or icons as shown in FIG. 2D.

As for input key of “Up key”, “Down key”, or “Select key” to user interface 10, a touch screen or key is used.

When a user searches the initial screen that is displayed on the displaying unit 60 by using the user interface unit 10, and then selects a corresponding apparatus or function, the selected apparatus or corresponding apparatuses to the function are displayed on the screen. This is well illustrated in FIG. 2B.

When the user selects a particular apparatus or function through the user interface unit 10 (S30), a control menu according to the selected apparatus or function and present operation state of the apparatus is displayed (S40). A preferable embodiment in this case is illustrated in FIG. 3C.

The user searches the control menu, and selects a control command for executing operation of the corresponding apparatus (S50).

Then, the corresponding apparatus executes relevant operation based on the input control command, and signals its operation state to the multipurpose remote controller again (S60).

Using the operation state information, if it turns out that the apparatus state has been changed or a new apparatus has been added or deleted at the result of comparison with the initial screen that is stored in the storage 50 (S70), the initial screen is updated, and the whole procedure is repeated (S80).

The procedure is ended by turning off the multipurpose remote controller (S90).

While the invention has been shown and described with reference to certain preferred embodiments thereof, it will be understood by those skilled in the art that various changes in form and details may be made therein without departing from the spirit and scope of the invention as defined by the appended claims.

### Industrial Applicability

In conclusion, the multipurpose remote controller and method for controlling the same according to the present invention has the following advantages:

First, it is now possible to control a plurality of apparatuses without any limit on space by controlling the plural networked apparatuses with the multipurpose remote controller.

Second, a user does not feel confused and can easily use the remote controller because the user selects a particular apparatus to be controlled through a screen and then controls the corresponding apparatus, thereby preventing waste of power consumption caused by operating unnecessary apparatuses.

What is claimed is:

1. A multipurpose remote controller, comprising:
a user interface unit to which a control command signal is input by a user from outside;
wire and wireless transmitting/receiving units for transmitting the control command signal input from the user interface unit to corresponding apparatuses, and for receiving operation state signals of the corresponding apparatuses;
a central processor for controlling the user interface and wire and wireless transmitting/receiving units;
a storage for storing data necessary to control the central processor, and
a display unit for displaying control keys under control of the central processor and for displaying operating state and results.

2. The remote controller according to claim 1, wherein the user interface comprises touch screen or keys.

3. A method for controlling a multipurpose remote controller, comprising the steps of:
configuring a home network for intercommunication by networking household apparatuses; selecting a particular apparatus to be controlled through an initial screen on which the networked apparatuses are divided according to apparatus or function;
displaying a control menu and present operation state of the particular apparatus;
selecting a control command for operating a corresponding apparatus through the control menu being displayed;
performing the corresponding operation as the selected control command is input, and then signaling the operation state of the apparatus to the multipurpose remote controller; and
if the state of the apparatus is changed or a new apparatus is added or an existing apparatus is deleted, updating the initial screen and then repeating the whole procedure.
